(19) United States
(12) Patent Application Publication
(10) Pub. No.: US 2025/0356425 A1
(43) Pub. Date: Nov. 20, 2025

(54) TRANSACTION TRACKING UTILITY

(71) Applicant: Wells Fargo Bank, N.A., San Francisco, CA (US)

(72) Inventors: John Hardy, Grove City, OH (US); Todd Schmitter, Saint Paul, MN (US); Alan Varrasso, Granville, OH (US); Steven Hagerman, Charlotte, NC (US)

(21) Appl. No.: 19/210,889

(22) Filed: May 16, 2025

Related U.S. Application Data
(60) Provisional application No. 63/649,608, filed on May 20, 2024.

(51) Int. Cl. G06Q 40/06

(52) U.S. Cl. CPC G06Q 40/06

(57) ABSTRACT

Systems and methods for capturing and tracking requests are provided. A method includes receiving a communication from a third-party computing device including request to interact with an application hosted by an enterprise and transforming the communication into a structured format thereby generating a request data object. The request data object includes a unique user identifier and user metadata associated with the request. The method also includes generating an enhanced request data object and storing the enhanced request data object into a transaction tracking database. The method includes processing the request data object, updating the enhanced request data object responsive to the processing, and outputting a control signal associated with one or more status indicators of the enhanced request data object.

### CROSS-REFERENCE TO RELATED APPLICATIONS

This application claims the benefit of and priority to U.S. Provisional Patent Application No. 63/649,608, filed on May 20, 2024, entitled “TRANSACTION TRACKING UTILITY,” the disclosure of which is hereby incorporated by reference in its entirety for all purposes.

### TECHNICAL FIELD

The present disclosure generally relates to tracking requests. More specifically, but not by way of limitation, this disclosure relates to techniques for capturing and tracking requests and supporting queries and analysis related to those requests.

### BACKGROUND

Institutions provide many services to a large variety of customers, users, and clients. To provide these services, institutions operate an increasingly complex array of inter-connected computer systems. Many of the existing computer systems have been in existence for decades and have been modified and enhanced throughout their existence to adapt to improvements in technical capabilities and to the needs of the customers. These modifications and enhancements have added more complexity to the systems. As a result of the increased complexity, if a technology disruption occurs, it can be difficult to track the status of a request thereby resulting in a poor experience for users. Further adding to this problem, a financial institution may process hundreds of thousands of users requests each day. Current solutions for monitoring these requests, detecting problems affecting users, and implementing solutions do not track such requests at the user level thereby resulting in inefficiencies in problem solving and negative impacts to the user experience.

### SUMMARY

Certain aspects and features of the present disclosure generally relate to computer-based systems and methods for capturing and tracking requests at the user/transaction level and supporting queries and analysis related to those requests. According to an aspect of the present disclosure, a method includes receiving, by a processor of a computing device, a communication from a third-party computing device. The communication can be associated with a request to interact with an application hosted by an enterprise associated with the computing device. The method includes transforming, by the processor and based on the request, the communication into a structured format using an application program interface (API) associated with the application specified in the request thereby generating a request data object. The request data object can comprise a unique user identifier and user metadata associated with the request. The method includes generating an enhanced request data object by injecting the request data object with additional metadata, the additional metadata including a unique service identifier. The method includes storing, by the processor, the enhanced request data object in a transaction tracking database. The transaction tracking database can include a plurality of enhanced request data objects categorized by application and indexed, for each categorized application, by respective timestamps, unique user identifiers, and unique service identifiers. The method includes processing, by the processor, the request data object using the application. Processing the request data object can comprise executing a plurality of processing steps performed by one or more computing systems associated with the application, wherein responsive to each processing step, the enhanced request data object is updated with a status indicator of each processing step. The method includes outputting, by the processor, a control signal associated with one or more status indicators of the enhanced request data object.

The above system may be implemented in a cloud service executed on cloud service provider infrastructure, which may include various servers, processors, and databases. The above system can also be implemented as computer-executable program instructions stored in a non-transitory, tangible computer-readable medium or media and/or operating within a system including one or more processors or other processing device and memory.

According to an additional aspect of the present disclosure, a system includes one or more processors and a memory coupled to the one or more processors. The memory includes instructions that, when executed by the one or more processors, cause the one or more processors to: receive, by a processor of a computing device, a communication from a third-party computing device, wherein the communication is associated with a request to interact with an application hosted by an enterprise associated with the computing device; transform, by the processor and based on the request, the communication into a structured format using an application program interface (API) associated with the application specified in the request thereby generating a request data object, wherein the request data object comprises a unique user identifier and user metadata associated with the request; generate an enhanced request data object by injecting the request data object with additional metadata, the additional metadata including a unique service identifier; store the enhanced request data object in a transaction tracking database including a plurality of enhanced request data objects categorized by application and indexed, for each categorized application, by respective timestamps, unique user identifiers, and unique service identifiers; process the request data object using the application, by executing a plurality of processing steps performed by one or more computing systems associated with the application, wherein responsive to each processing step, the enhanced request data object is updated with a status indicator of each processing step; and output a control signal associated with one or more status indicators of the enhanced request data object.

An additional example includes a non-transitory computer-readable medium embodying program code that is executable by one or more processors to cause the one or more processors to: receive, by a processor of a computing device, a communication from a third-party computing device, wherein the communication is associated with a request to interact with an application hosted by an enterprise associated with the computing device; transform, by the processor and based on the request, the communication into a structured format using an application program interface (API) associated with the application specified in the request thereby generating a request data object, wherein the request data object comprises a unique user identifier and user metadata associated with the request; generate an enhanced request data object by injecting the request data object with additional metadata, the additional metadata including a unique service identifier; store the enhanced request data object in a transaction tracking database including a plurality of enhanced request data objects categorized by application and indexed, for each categorized application, by respective timestamps, unique user identifiers, and unique service identifiers; process the request data object using the application, by executing a plurality of processing steps performed by one or more computing systems associated with the application, wherein responsive to each processing step, the enhanced request data object is updated with a status indicator of each processing step; and output a control signal associated with one or more status indicators of the enhanced request data object.

### BRIEF DESCRIPTION OF THE DRAWINGS

Various non-limiting examples are further described with reference to the accompanying drawings, in which:

FIG. 1 is a block diagram of an example of a computing environment usable for tracking requests, according to some aspects of the present disclosure;

FIG. 2 is a sequence diagram of an example process for tracking requests and supporting queries and analysis related to those requests, according to some aspects of the present disclosure;

FIG. 3 is a block diagram illustrating an example of a computing system usable to implement some aspects of the present disclosure; and

FIG. 4 is a flowchart of an example of a process for tracking requests, according to some aspects of the present disclosure.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration.” Any embodiment or design described herein as “exemplary,” or “example” is not necessarily to be construed as preferred or advantageous over other embodiments or designs

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalent.

### Illustrative Example for Capturing and Tracking Requests at the User/Transaction Level and Supporting Queries and Analysis Related to Those Requests

Certain aspects and features of the present disclosure relate to a service requests tracking architecture capable of tracking service requests at the user/transaction level in an enterprise. The architecture can capture service request data associated with a customer request and track the request from start to finish. The architecture can also provide support for queries (e.g., real-time or ad-hoc) of the service request to determine a status of the service request. The architecture can also support analysis and reporting related to service requests for use by an enterprise to problem solve and improve the overall user experience.

As one particular example, a system implementing the service request tracking architecture receives an initial communication from a third-party computing device. The communication is associated with service request specifying a particular action the third-party computing device would like to be performed by the system (herein referred to as a “request”). That is, the request can be associated with a user requesting to interact with an application or feature provided by an enterprise. Non-limiting examples of such requests include a transfer of funds via mobile application (E.g., Zelle®), a wire transfer of funds, depositing a check, an automated clearing house (ACH) electronic funds transfer (ETF), updating personal information of an online profile associated with the enterprise, and the like. Depending on the type of request (e.g., the action specified by the request and the respective application hosted by the enterprise suitable to execute the request) and the computing systems utilized by the enterprise, the request is processed and formatted appropriately into a request data object. Such processing and formatting may be performed by suitable application program interfaces (APIs), event publishers, and file generators. The generated request data object includes information about the request such as an enterprise customer number (ECN), account number associated with the customer, date, time, and details of the request.

After the request data object is generated, the service request tracking architecture enhances the request data object by adding additional information (e.g., metadata) to the request data object to thereby generate an enhanced data object. For example, the service request tracking architecture can assign a unique service request identifier to the request data object. In certain examples, the unique service request identifier is selected from a predefined list of sequential numbers. In other examples, the unique service request identifier can be generated by a random number generator. In yet other examples, the identifier can be a sequence of one or more numbers, letters, symbols, and/or other characters generated by a random alphanumeric generator. In other examples, the additional information can include a time stamp associated with the unique service request identifier that specifies a start time for processing of the request data object. In general, the unique service request identifier is a unique label generated for each request that can be used to uniquely identify individual requests. The service request tracking architecture then processes the incoming request data into a standardized format, and an API integrated in the service request tracking architecture then stores the enhanced request data object, including the additional metadata, into a transaction tracking database.

It will be appreciated that service requests received by the system from third-party computing devices typically interact with multiple systems, applications, or programs of an enterprise as they are processed from start to finish. As such, each system, application, or program can utilize an interface to publish an event, create a file, or use an API to update a status of the service request as the service request is processed. More specifically, after the enhanced request data object is stored into the transaction tracking database, the system implementing the service request tracking architecture monitors the progress of the request and updates a status indicator of the enhanced request data object as the request traverses (e.g., is processed) through the various computing systems, applications, or programs. As each processing step is performed, the status indicator for that processing step can be updated in the enhanced request data object stored in the transaction tracking database to indicate a success or a failure of the respective processing step.

As the request is processed from start to finish, it is possible that a processing step is not completed properly. As a result, the service request tracking architecture identifies this error (through an interface publishing an event failure, for example) and updates the status indicator of the enhanced request data object stored in the transaction tracking database. Responsive to identifying the failure, the system resolves exceptions associated with the failure. For example, the service request tracking architecture can attempt to run the request a second (e.g., replay it). The service request tracking architecture can also perform an undo function whereby processing of the request is reversed thereby returning the user associated with the request to the original position they were in before submitting the request. As yet another example, the service request tracking architecture can generate and output a reporting data object indicating the failure. The reporting data object can be generating an output based on periodic metrics and trends or incident impact reporting. The reporting data object functionality can involve identifying other users in the transaction tracking database that may experience a similar failure, and as a result, the system implementing the service request tracking architecture can resolve the failure/exception before subsequent failures for additional users arise.

After the exception has been resolved, the system implementing the service request tracking architecture verifies that the request has been completed properly. After verification, the enhanced request data object can be updated in the transaction tracking database as complete to indicate proper completion. Updating the enhanced request data object to complete can also include removing the enhanced request data object from the transaction tracking database to free up memory space for subsequent requests.

Numerous benefits are achieved by way of the present disclosure over conventional techniques. For example, the techniques described herein provide an approach for improving user experience by tracking requests from start to finish and by taking active and real-time steps to detect, prevent, and resolve problems quickly. The techniques accomplish this objective through early notification of potential and actual problems; assignment of a unique identifier to each request; automated resolution of common problems; queries that quickly identify affected customers; report generation on a status of specific requests; and regular reporting that detects trends for proactive intervention before problems occur. Systems and methods for capturing and tracking the status of requests and supporting queries and analysis related to those requests are useful for enterprises in efficiently standardizing processes and problem solving across multiple applications and back-end processing to improve the customer experience and efficiency in enterprise processes, including improving efficiency in technical fields such as software development. The techniques described herein also maintain security of transaction data across the enterprise by authenticating user identity based on account data and assigning unique request identifiers. This provides for problem solving at the user and transaction level in a manner that is efficient and less computationally or manually intensive.

These illustrative examples are given to introduce the reader to the general subject matter discussed herein and are not intended to limit the scope of the disclosed concepts. The following sections describe various additional features and examples with reference to the drawings in which like numerals indicate like elements but, like the illustrative examples, should not be used to limit the present disclosure.

### Example Systems for Capturing and Tracking Requests at the User/Transaction Level and Supporting Queries and Analysis Related to Those Requests

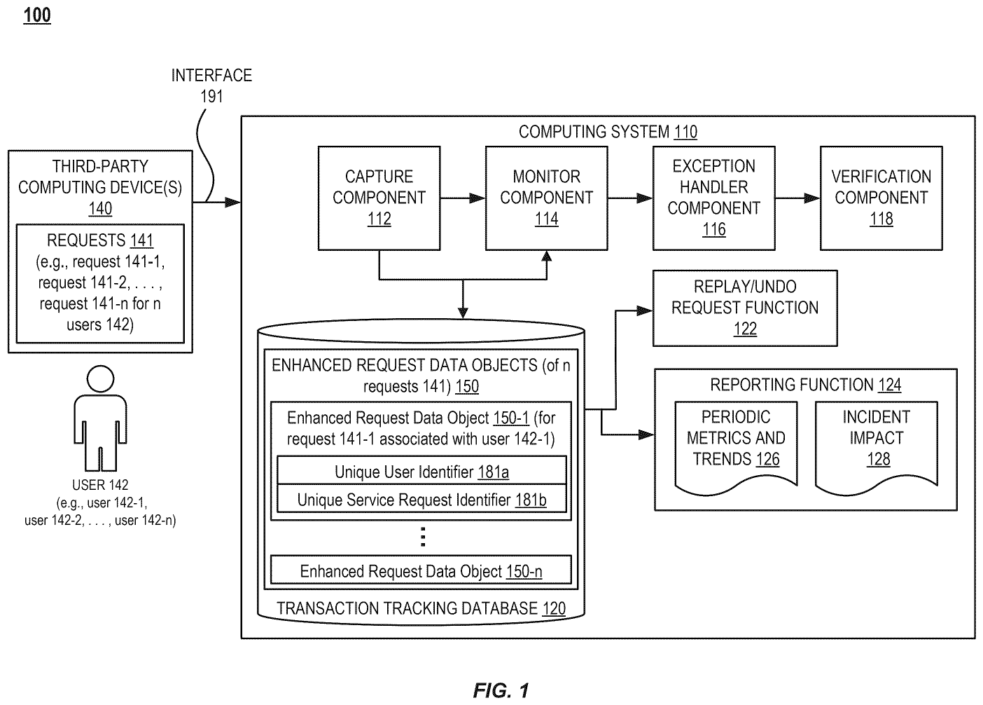

Turning now to the figures, FIG. 1 is a block diagram of an example of a computing environment 100 usable to implement some aspects of the present disclosure. Included in computing environment 100 is third-party computing device(s) 140 communicatively coupled (e.g., by a network connection, not shown) to computing system 110. Third-party computing device(s) 140 can be associated with a variety of different users, sources, or computing devices having a technical and/or business relationship with an enterprise hosting computing system 110 whom can benefit from the service request tracking architecture described herein.

As shown in FIG. 1, third-party computing device(s) 140 can generate requests 141 (e.g., request 141-1, request 141-2, . . . , request 141-n) associated with users 142 (e.g., user 142-1, user 142-2, . . . , user 142-n). That is, request 141-1 may be associated with user 142-1, request 141-2 may be associated with user 142-2, and so on. Requests 141 can include, for example, requests submitted to computing system 110 to interact with one or more applications hosted by the enterprise responsible with hosting computing system 110. Such requests may include a request for monetary activity such as a person-to-person payment, send a wire transfer, an ACH deposit, etc.). Other requests can requests such as updating account information (e.g., change an address), account servicing requests (e.g., reprinting a credit card statement), and the like.

Computing environment 100 also includes interface 191. Interface 191 can provide the technical means by which third-party computing device(s) 140 submitting requests 141 may interface with the service request tracking architecture hosted by computing system 110. In some examples, interface 191 can be the Internet. In other words, interface 191 can capture the incoming requests 141 (e.g., capture the request of sending a wire transfer) and generate request data associated with the request. One example of capturing a request from third-party computing device(s) 140 includes an API call. Calling the API can refer to one program interacting with another program/application. In other words, an API call can be a message sent from interface 191 to the computing system 110 with information associated with the requests 141 generated by third-party computing device(s) 140. As another action, capturing a request from third-party computing device(s) 140 can include utilizing an event publisher to publish an event associated with the request. The event can describe details associated with the service request that can be received for processing by the computing system 110. Yet another example of capturing a request from third-party computing device(s) 140 includes generating a file containing information associated with the request.

After interface 191 captures the request from at least one third-party computing device(s) 140, the captured request is received as input by computing system 110. Computing system 110 can be configured to perform the processing techniques associated with the service request tracking architecture. As illustrated by FIG. 1, computing system 110 can include various components included for implementing the operations associated with the processing techniques described by the present disclosure. It will be appreciated that these various components are implemented by at least one processor of computing system 110, even though they may be described herein as performing functions for simplicity.

The first block in the computing system 110 can be a capture component 112. Capture component 112 can capture the request data generated from one of the standard interfaces discussed above in relation to interface 191 (e.g., the event publisher, API call, or generated file) associated with third-party computing device(s) 140. As discussed above, the request, also referred to herein as a “communication,” is associated with a service request to interact with an application hosted by an enterprise associated with the computing device 110. In an implementation, the capture component 112 can transform the communication into a structured format, such as a standardized format, using an application program interface (API) associated with the application specified in the request to thereby generate a request data object. Standardizing the format of the request data ensures that all the request data stored in the transaction tracking database 120 shares a common format, structure, and organization.

The capture component 112 can also perform additional operations on the request data object received from interface 191. More specifically, capture component 112 can receive the incoming request data object (e.g., the payload of the request) and store it in a transaction tracking database 120. Before storing the request data object in the transaction tracking database 120, the capture component 112 can insert additional metadata into the request data object. For instance, the capture component 112 can generate a unique user identifier associated with the request data object. In addition, the capture component 112 can also insert a unique service identifier into the request data object. The combination of the unique user identifier, which may be a user account number associated with a particular user 142 of requests 141, and the unique service identifier link the service request to the particular user. In certain examples, the identifier is selected from a predefined list of sequential numbers. In other examples, each of the unique user identifier or the unique service identifier (the “identifiers”) can be generated by a random number generator. In other examples, the identifiers can be a sequence of one or more numbers, letters, symbols, and/or other characters generated by a random alphanumeric generator. In other examples, a time stamp can be associated with the identifiers that specifies a start time for the service request. In other examples, the requests 141 can be categorized by application and the request data object may include a type of application. In general, the identifiers are a unique label generated for each request received by the computing systems of an enterprise that can be used to uniquely identify individual requests. The capture component 112 can also enhance the initial request data with an enterprise customer number (ECN), a transaction type, account number, and the like.

The process of receiving and enhancing the request data object associated with requests 141 can generate enhanced request data objects 150. As shown in FIG. 1, such enhanced request data objects 150 may be associated with n requests 141 and stored in transaction tracking database 120. That is, enhanced request data object 150-1 may be associated with request 141-1 associated with user 142-1. The enhanced request data objects 150 stored in transaction tracking database 120 can include at least a unique user identifier (e.g., unique user identifier 181a for enhanced request data object 150-1) and at least a unique service request identifier 181b (e.g., unique service request identifier 181b for enhanced request data object 150-1). Thus, the transaction tracking database 120 can include a plurality of enhanced request data objects 150 categorized by application and indexed, for each categorized application, by respective timestamps, respective unique user identifiers, respective unique service identifiers, or other forms of metadata Generating the enhanced request data objects 150 enables the service request tracking architecture implemented by computing system 110 to identify requests 141 at the user/transaction level as each request will have a unique user identifier and unique service request identifiers.

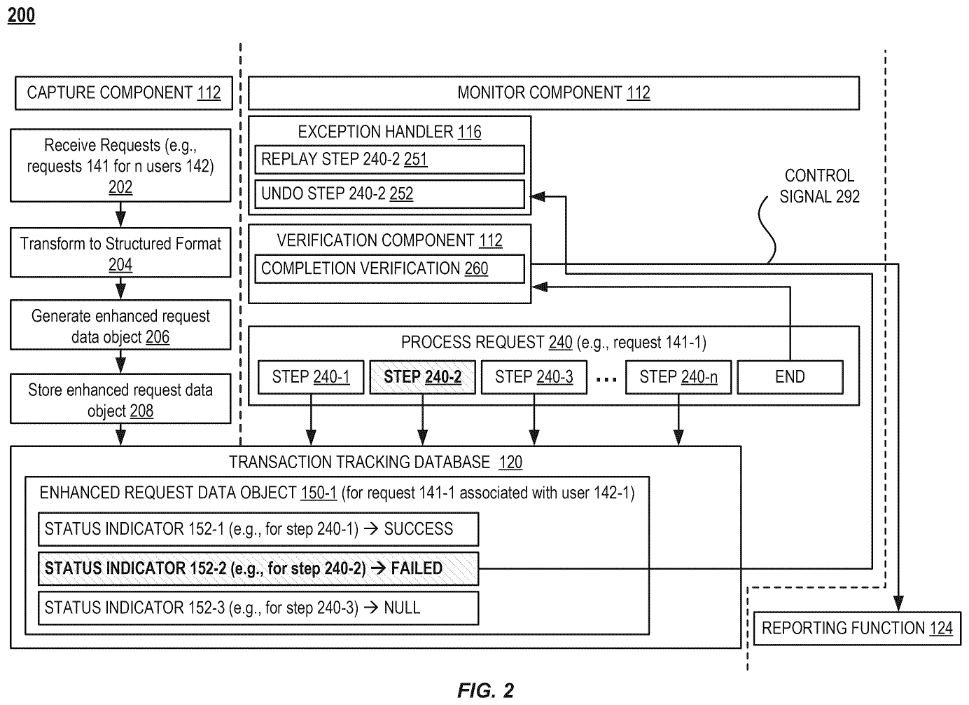

The transaction tracking database 120 can keep a record of the requests 141. The transaction tracking database 120 can also keep a record of the progress of processing requests 141 through various phases or steps required to complete the request, as described with respect to FIG. 2. As mentioned above, a service request (e.g., a transfer money request) can require multiple applications and processing steps within an enterprise infrastructure to be completed. As such, the transaction tracking database 120 can include the initial request data as well as a record of each published event, API call, or file generated by subsequent computing systems/applications/programs as the request is processed from start to finish through the enterprise infrastructure.

As further illustrated by FIG. 1, computing system 110 also includes a monitor component 114. As illustrated by the double arrows connecting the monitor component 114 to the transaction tracking database 120, the monitor request progress component 114 can generate updates to the record associated with the request data stored in the transaction tracking database 120. Updates to the record, as described above, will be generated as the request is processed through the various applications and computing systems of an enterprise. The techniques described herein provide various examples of different mechanisms for monitoring the request progress that may be implemented the processor at the monitor component 114. As one example, the monitor component 114 can receive updates on a periodic basis (e.g., a query that is performed after a pre-determined amount of time) from the variety of applications and computing systems that are required to take action in the completion of the request. When the query is performed, each application or computing system involved in completing the request can call a standard interface (e.g., an API call) to provide an updated status of their respective portion of the request.

As another example associated with the monitor component 114, metadata associated with the request can be analyzed and updated. For example, for each source of requests offered by an enterprise, there can be a predefined list of steps associated with each processing step involved in completing the request. For example, if the source of the request is a wire transfer between two people, a predefined list of processing steps implemented by the computing systems of an enterprise responsible for completing the wire transfer can be accessed, analyzed, and updated as the request is processed. Accordingly, each application or computing system associated with performing the request can update the predefined list upon completion of the respective step, and the monitor component 114 can access this list to determine the progress of the request. Additionally, the monitor component 114 could perform a real-time query to return the current status of a request, where the real-time query returns the list or the results from the periodic updates described above.

The computing system 110 also includes an exception handler component 116. The exception handler component 116 can utilize various mechanisms to resolve common exceptions and problems identified by the monitor component 114. For example, the exception handler component 116 can utilize a replay/undo request function 122 to retry failed requests or to back out requests made in error. As one particular example, a user may attempt a request of transferring money from their checking account to the checking account of a landlord to pay rent for the month. In this example, the user submits the transfer of money, and the funds are subsequently credited from her account. However, in this hypothetical example, as the transfer is processed through the enterprise, an error arises and the transfer is not completed (e.g., the funds are not deposited in the landlords checking account). When this error is identified by the monitor component 114, the service request tracking architecture can move to the exception handler component 116. To resolve the exception, the replay/undo request function 122 can “undo” the transfer and deposit the funds back into the account of the user. Additionally, or alternatively, the replay/undo function 122 can attempt to retry the transfer. In one example, the exception handler component 116 can route the request data object, or a particular processing step, to a different computing system or component of the computing system 110.

The exception handler component 116 can also perform event based triggered resolving of exceptions (e.g., an exception function). Along the chain of a request, there can be an error that is identified by the monitor component 114. Computing system 110, can receive an indication of the error and then provide a real-time notification or a real-time alert to the user who submitted the request indicating that there was an error and that the enterprise is working on a solution. In some examples, the notification can be a real-time notification provider to the user who submitted the request. This functionality of the exception handler component 116 can improve the customer experience because the customer will receive a real-time notification or a real-time alert about the status of their request thereby providing them with information about the status of the request in an efficient manner. This functionality can also save computation resources because rather than the customer calling the enterprise or submitting an online inquiry related to the problem followed by the enterprise having to diagnose the problem, the functionality of the described techniques provides an automated solution to let the customer know about the status of the request.

Moreover, the exception handler component 116 can resolve exceptions through a periodic review or query of the processing steps involved with the request. This can also include a periodic review of updates to the predefined list of processing steps associated with a request. In other words, a periodic review can enable continuous monitoring of the request. Similar to the previous example, this functionality can be integrated with automated problem solving. As a particular example, the request can be associated with the posting of an incoming transfer payment to the recipient's account through a money transfer application (e.g., Zelle®). The predefined list associated with this type of request can include the processing steps associated with the transfer. As part of this predefined list, each processing step can include an indication of an average amount of time involved with completing the step. In one non-limiting example, assume that the posting of a transfer through Zelle® is completed within 60 seconds of initiation. Based on this average time, the exception handler component 116 could perform a periodic query of the request every 5 seconds. Through the periodic querying, the exception handler component 116 identifies that the request has not been completed after 2 minutes of processing and that the request has not passed through a particular processing step in the chain of processing steps. In response to this determination, the exception handler component 116 can perform an automated solution (e.g., replay/undo request, send notification to the customer, etc.) to attempt to solve the problem.

The exception handler component 116 also performs operations in tandem with reporting function 124. In one example, reporting function 124 can provide reporting of current exceptions (e.g., problems/issues) requiring resolution. An enterprise may process hundreds of thousands of request every hour or day, for example. Reporting function 124 can report on the status of these hundreds of thousands of requests through periodic metrics and trends 126 or incident impact 128 to provide information to the enterprise about the overall health of the computing systems of the enterprise. For example, periodic metrics and trends 126 can perform a check of the enterprise computing systems for a given timeframe to determine the overall success or failure rate associated with processing requests. The trends can be generalized to all requests or based on a particular type of request.

Additionally, reporting function 124 can also provide reporting by incident impact 128. The incident impact 128 can access data associated with a request or a group of requests and determine a group of customers that may be impacted by a particular problem (e.g., all customers located on the West Coast). The computing system 110 can then use this reporting to globally solve the identified problem or notify all impacted customers with an indication of the problem and that a resolution is being worked on. Resolving exceptions quickly and efficiently at this scale is difficult or impossible for a human to accomplish. For example, a human would not be able to analyze hundreds of thousands of progress reports associated with requests stored in a transaction tracking database to identify all impacted customers and then efficiently distribute a notification of the problem to all impacted customers.

Reporting function 124 can also generate regular, periodic reporting. These reports can be utilized by an enterprise to aid in pro-active identification of potential problem trends. Analysis associated with the reporting can enable an enterprise to continuously improve their computing systems to avoid future problems with technology disruptions. Limiting the amount of technology disruptions and identifying trends can improve the overall customer experience.

Computing system 110 can also include a verification component 118. Verification component 118 can perform a check to ensure each request is completed and not otherwise left indefinitely in an incomplete state. The verification component 118 can then update a status of the request in the transaction tracking database 120 to indicate when the request has been completed successfully. In some examples, a user with access to the unique request identifier could provide the unique request identifier as a search query to check on a real-time status associated with their request to verify where the request is in the processing chain or to verify completion.

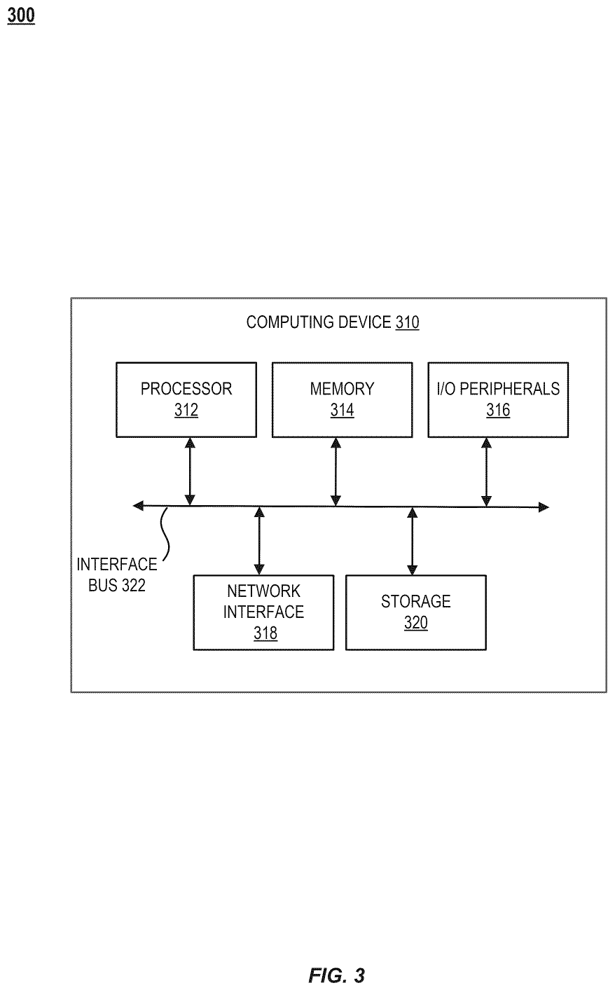

FIG. 2 is a sequence diagram of an example process 200 for tracking requests and supporting queries and analysis related to those requests, according to some aspects of the present disclosure. The process 200 will be described with respect to the computing system 110 shown in FIG. 1; however, any suitable system or platform according to this disclosure may be employed, including the example computing device 310 shown in FIG. 3. Additionally, process 200 is provided in the order shown, but other orders or additional steps may be provided.

Process 200 begins at block 202 where capture component 112 receives requests 141 from users 142 from third-party computing device(s) 140. In some implementations, block 202 can refer to a capture job run data processing stage of the service requests tracking architecture. In the capture job run data processing stage, the request associated with a third-party computing device can be captured and categorized in accordance with a particular application type described in the request. In some implementations, applications with batch jobs, can produce one or more files associated with the requests for processing by the service requests tracking architecture. Additionally, and to track the individual requests in these files back to originating third-party computing device, the batch job can also capture a specific instance of the job by accessing a job instance data object and/or a file instance data object. The job instance data object can include data about the batch job (e.g., job name, start time, end time, status, etc.) and the file instance data object can include data about the generated file (e.g., file name, time created, number of records, and job name).

At block 204, the capture component 112 can transform the requests into a structure format. At block 206, the capture component 112 can generate enhanced request data objects 150. At block 208, the capture component 112 can store the enhanced request data objects 150 into the transaction tracking database 120. Details regarding the processing steps associated with blocks 204-208 are discussed above in relation to FIG. 1. In general, the capture component 112 can parse incoming requests and extract relevant information contained within the requests. Then, the capture component 112 can generated the enhanced request data object and execute a store API to store the request data into the transaction tracking database.

As will be apparent to one of ordinary skill, the various mechanisms for capturing request data may not share a common format. For example, certain applications may generate requests in the form of files which may be in a different format than requests published as events by a different application. Thus, to resolve the differences in the varying formats, the request data that is stored into the transaction tracking database can be mapped into a standard format by the capture component 112. For example, the incoming files can be parsed by using a file parser included in the capture component 112 to perform the mapping. Including the file parser within the capture component 112 creates a separate processing step for the service request tracking architecture. As a result, each application involved in processing requests need not create their own parsing logic. The file parser can include tooling to enable drag-and-drop style mapping that generates code that can parse the incoming files into the standard format and then call the store transaction API.

Once stored in the transaction tracking database 120, processing of the request may begin whereby processing of the request may be monitored by monitor component 112. FIG. 2 illustrates the processing of a particular request (e.g., request 141-1). As shown, process request 240 block processes request 141-1. Request 141-1 includes a plurality of processing steps broken up in sequential order as step 240-1, step 240-2, step 240-3, . . . , step 240-n. As shown in FIG. 2, as each processing step is performed, the monitor component 112 can monitor a success or failure of the processing step and update a status indicator of the enhanced request data object 150-1 in the transaction tracking database 120. For instance, step 240-1 was successful processed to completion and as a result status indicator 152-1 (e.g., for step 240-1) was updated to SUCCESS. Processing step 240-2 was not successfully processed to completion and as a result status indicator 152-2 was updated to FAILED. Responsive to the failure, monitor component 112 can execute exception handler 116 to implement a replay of step 240-2 (e.g., replay 251) or an undo of step 240-2 (e.g., undo 252) as discussed with respect to FIG. 1. The exception handler 116 may re-process the step 240-2 until the processing step is completed successfully. As shown, status indicators for processing steps that have not occurred yet (e.g., processing step 152-3) may be defaulted to NULL. In some implementations an update request API implemented by monitor component 112 can update the status indicator of the enhanced request data object 150-1. The update transaction API can be called directly by various applications, or it can be called by monitor component 112 responsive to updates in the process request 240 block.

The process request 240 block may continue processing request 141-1 until completion. As shown in FIG. 2, at the end of process request 240 a control signal 292 and generated and transmitted to verification component 112 whereby completion verification 260 is executed to evaluate the request 141-1 and determine whether the request 141-1 has truly been successfully completed. This can involve accessing, by the verification component 112, the enhanced request data object 150-1 in the transaction tracking database 120 to determine if each status indicator has a SUCCESS indication. In one implementation, upon determining that the processing of request 141-1 is completed, the control signal 292 can automatically cause removal of the respective enhanced request data object from the transaction tracking database 120 to thereby free up a memory space of the transaction tracking database.

In one implementation, the verification component 112 can be configured to compare the expected processing steps for a particular request type (based on predefined metadata about the request type) with the actual processing steps completed. That is, the computing system 110 may include predefined metadata associated with each processing step of common requests. Then, the verification component 112 can extract this metadata and compare the action processing steps performed by process request 240 to the predefined list. Verification component 112 can then return a listing of the expected processing steps (e.g., based on the metadata of predefined list) and the actual completed processing steps. Based on the comparison satisfying a threshold (e.g., a threshold number of processing steps were completed successfully), the verification component 112 can update the state of the transaction to complete.

It will be appreciated that applications may differ with respect to how the request is tracked and processed from start to finish. For instance, some applications may publish event logs associated with requests whereby the applications are configured to call a common store request API to thereby update the enhanced request data object associated with that request. As another example, some applications may not publish events or files, but rather, call a common store transaction API directly to record arrival and processing of an incoming request. As yet another example, applications with batch jobs can produce files that contain the data associated with service request. One of ordinary skill in the art would recognize many variations, modifications, and alternatives.

Also included in process 200 is reporting function 124. In some implementations, reporting function 124 can be executed upon completion of processing of request 141-1. As described with respect to FIG. 1, reporting function 124 can include periodic metrics and trends 126 reporting and incident impact 128 reporting. Periodic metrics and trends 126 can run at predefined intervals to produce reporting for review by production monitoring staff of the enterprise and can share the same description as the reporting function 124 described above in relation to FIG. 1. The reporting can be used to identify warning trends for potential problems with the objective of intervening before problems occur. The reporting can also be used to identify opportunities for improvement by identifying patterns and can support on demand reporting to identity the affected customer population for active incidents.

FIG. 3 is a block diagram illustrating an example 300 of a computing system 310 usable to implement some aspects of the present disclosure. In one configuration, the computing system 310 may include at least one processor 312 and at least one memory 314. Depending on the exact configuration and type of computing device, the at least one memory 314 may be volatile, such as RAM, non-volatile, such as ROM, flash memory, etc., or a combination thereof. Examples of processor include a microprocessor, an application-specific integrated circuit (ASIC), a field-programmable gate array (FPGA), or any other suitable processing device. Computing device can include one processor, such as is illustrated by processor 312 in FIG. 3, or more than one processor.

Computing device may include additional features or functionality. For example, the computing device may include additional storage such as removable storage or non-removable storage, including, but not limited to, magnetic storage, optical storage, etc. Such additional storage is illustrated in FIG. 3 by storage 320. In one or more embodiments, computer readable instructions to implement one or more embodiments provided herein are in the storage. The storage 320 may store other computer readable instructions to implement an operating system, an application program, etc. Computer readable instructions may be loaded in the at least one memory for execution by the at least one processor, for example.

Computing devices may include a variety of media, which may include computer-readable storage media or communications media, which two terms are used herein differently from one another as indicated below.

Computer-readable storage media may be any available storage media, which may be accessed by the computer and includes both volatile and nonvolatile media, removable and non-removable media. By way of example, and not limitation, computer-readable storage media may be implemented in connection with any method or technology for storage of information such as computer-readable instructions, program modules, structured data, or unstructured data. Computer-readable storage media may include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which may be used to store desired information Computer-readable storage media may be accessed by one or more local or remote computing devices (e.g., via access requests, queries, or other data retrieval protocols) for a variety of operations with respect to the information stored by the medium.

Communications media typically embody computer-readable instructions, data structures, program modules, or other structured or unstructured data in a data signal such as a modulated data signal (e.g., a carrier wave or other transport mechanism) and includes any information delivery or transport media. The term “modulated data signal” (or signals) refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media. Still referring to FIG. 3, the computing system 310 may also include a number of additional external or internal devices, for example, input or output devices. For example, computing device is illustrated as including input/output (I/O) peripherals 316. I/O peripherals 316 can receive inputs from input devices or provide outputs to output devices (not shown). Input peripherals can include a variety of different input devices such as keyboards, mouses, pens, voice input devices, touch input devices, infrared cameras, video input devices, or any other input device. Output peripherals can include a variety of different output devices such as one or more displays, speakers, printers, or any other output device may be included with the computing device. I/O peripherals 316 may be connected to the computing device via a wired connection, wireless connection, or any combination thereof. The various components of computing system 310 may be communicatively coupled together along interface bus 322. Although only one interface bus is illustrated, the computing device can include more than one interface bus. Computing system 310 can also include network interface 318 which can be used to communicatively connect the computing system 310 to other computing systems, client devices, etc. via a network.

### Example Methods for Capturing and Tracking Requests at the User/Transaction Level and Supporting Queries and Analysis Related to Those Requests

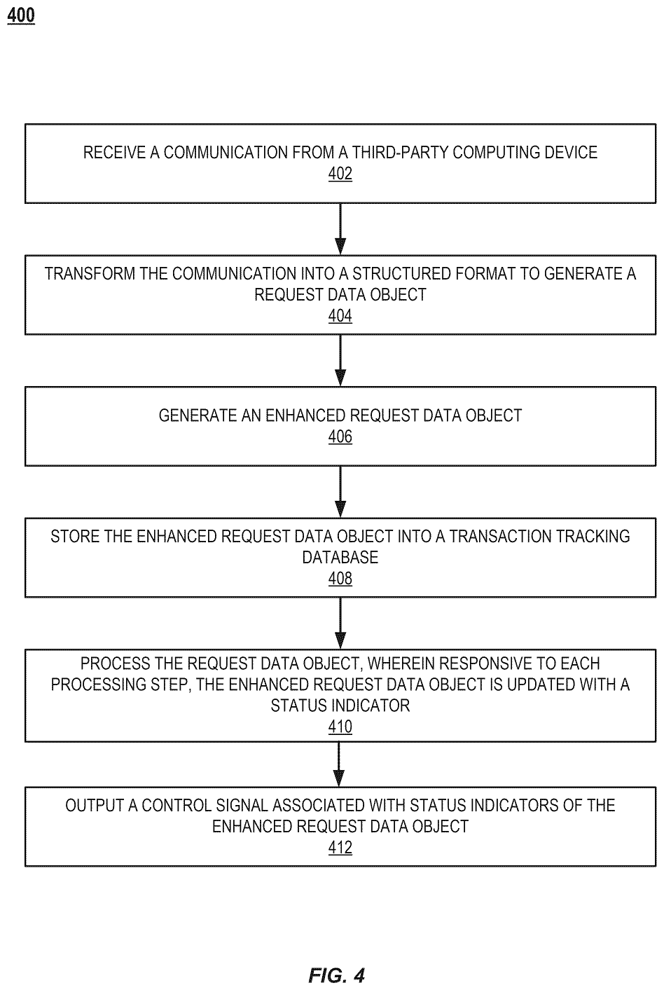

FIG. 4 is a flowchart of an example of a process for tracking requests, according to some aspects of the present disclosure. The process 400 will be described with respect to the computing environment 100 described with respect to FIG. 1 and with respect to the sequence diagram illustrating process 200 described with respect to FIG. 2; however, any suitable system or platform according to this disclosure may be employed, including the example computing device 310 shown in FIG. 3. Additionally, process 400 is provided in the order shown, but other orders or additional steps may be provided.

As shown in FIG. 4, process 400 begins at step 402 where computing system 110 receives a communication (e.g., a request of request 141) from a third-party computing device (e.g., from third-party computing device(s) 140). The communication can be received over interface 191, such as the Internet. The communication can be associated with a request from the third-party computing device to interact with an application hosted by an enterprise associated with the computing device 110. Non-limiting examples of such requests include a transfer of funds via mobile application (E.g., Zelle®), a wire transfer of funds, depositing a check, an automated clearing house (ACH) electronic funds transfer (ETF), updating personal information of an online profile associated with the enterprise, and the like.

At block 404, the capture component 112 of the computing device 110 can transform the communication into a structured format to generate a request data object. For example, capture component 112 can transform the communication into a structured format, such as a standardized format, using an application program interface (API) associated with the application specified in the request to thereby generate a request data object. Standardizing the format of the request data ensures that all the request data stored in the transaction tracking database 120 shares a common format, structure, and organization. Non-limiting examples of standardized formats include a JavaScript Object Notation (JSON) format, an Extensible Markup Language (XLM) format, a Comma-Separated Values (CSV) format, and the like.

At block 406, the capture component 112 can generate an enhanced request data object (e.g., one of enhanced request data objects 150) by injecting the request data object with additional metadata. As described with respect to FIG. 1, enhanced request data objects 150 can include at least a unique user identifier (e.g., unique user identifier 181a for enhanced data object 150-1) and at least a unique service request identifier 181b (e.g., unique service request identifier 181b for enhanced request data object 150-1). Each of the identifiers can be generated by a random number generator. In other examples, the identifiers can be a sequence of one or more numbers, letters, symbols, and/or other characters generated by a random alphanumeric generator. The enhanced request data object can also include additional data, such as a time stamp that specifies a start time for processing the service request. In some examples, the unique user identifier may be associated with an account number or other user profile information extracted from an account of the user maintained by the enterprise hosting the computing system 110.

At block 408, the capture component 112 can store the enhanced request data object into the transaction tracking database 120. The transaction tracking database 120 can include a plurality of enhanced request data objects 150 categorized by application and indexed, for each categorized application, by respective timestamps, respective unique user identifiers, respective unique service identifiers, or other forms of metadata. Generating the enhanced request data objects 150 enables the service request tracking architecture implemented by computing system 110 to identify requests 141 at the user/transaction level as each request will have a unique user identifier and unique service request identifiers.

At block 410, computing system 110 can process the request data object using process request 240. During processing, monitor component 112 may monitor completion of each processing step. More specifically, and as described with respect to FIG. 2 and the example processing of request 141-1, each service request may include a plurality of processing steps (e.g., step 240-1, step 240-2, step 240-3, . . . , 240-n). The monitor component 112 can monitor a success or failure of the processing step and update a status indicator of the enhanced request data object 150-1 in the transaction tracking database 120. For instance, step 240-1 was successful processed to completion and as a result status indicator 152-1 (e.g., for step 240-1) was updated to SUCCESS. Processing step 240-2 was not successfully processed to completion and as a result status indicator 152-2 was updated to FAILED. Responsive to failures in the processing, monitor component 112 can execute exception handler 116 to implement a replay of step 240-2 (e.g., replay 251) or an undo of step 240-2 (e.g., undo 252) as discussed with respect to FIGS. 1 and 2.

In some implementations, a status indicator of the enhanced request data object can be updated based on a timestamp data analysis. That is, at the beginning of each processing step a timestamp may be generated. Monitor component 112 may monitor a timing window of the processing step by comparing the start timestamp to the present timestamp. If the timing window exceeds a threshold, the threshold may be satisfied. Upon determining that the timing threshold is satisfied, the monitor component may update the status indicator of the enhanced request data object to FAILED. The timing threshold may be set based on an average time it should take to complete the processing step based on historical data.

Upon completion of processing the request, computing system 110, at block 412, can output a control signal 292 associated with status indicators of the enhanced request data object. As described with respect to FIG. 2, verification component 112 can receive control signal 292 whereby completion verification 260 is then executed to evaluate the request 141-1 and determine whether the request 141-1 has truly been successfully completed. This can involve accessing, by the verification component 112, the enhanced request data object in the transaction tracking database 120 to determine if each status indicator has a SUCCESS indication. In one implementation, upon determining that the processing of request is completed, the control signal 292 can automatically cause removal of the respective enhanced request data object from the transaction tracking database 120 to thereby free up a memory space of the transaction tracking database 120. In some examples, the control signal 292 can cause the computing system 110 to automatically send a notification to a user of the communication that the request has been performed successfully.

### General Considerations

Numerous specific details are set forth herein to provide a thorough understanding of the claimed subject matter. However, those skilled in the art will understand that the claimed subject matter may be practiced without these specific details. In other instances, methods, apparatuses, or computing systems that would be known by one of ordinary skill have not been described in detail so as not to obscure claimed subject matter.

Unless specifically stated otherwise, it is appreciated that throughout this specification discussions utilizing terms such as “generating,” “processing,” “computing,” and “determining” or the like refer to actions or processes of a computing device, such as one or more computers or a similar electronic computing device or devices that manipulate or transform data represented as physical electronic or magnetic quantities within memories, registers, or other information storage devices, transmission devices, or display devices of the computing platform.

The computing system or computing systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes,” “having,” “has,” “with,” or variants thereof are used in either the detailed description or the claims, such terms are intended to be inclusive in a manner similar to the term “comprising.” The use of “configured to” or “based on” herein is meant as open and inclusive language that does not foreclose devices adapted to or configured to perform additional tasks or steps. The endpoints of comparative limits are intended to encompass the notion of quality. Thus, expressions such as “more than” should be interpreted to mean “more than or equal to.”

Where devices, computing systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A method comprising:
receiving, by a processor of a computing device, a communication from a third-party computing device, wherein the communication is associated with a request to interact with an application hosted by an enterprise associated with the computing device;
transforming, by the processor and based on the request, the communication into a structured format using an application program interface (API) associated with the application specified in the request thereby generating a request data object, wherein the request data object comprises a unique user identifier and user metadata associated with the request;
generating, by the processor, an enhanced request data object by injecting the request data object with additional metadata, the additional metadata including a unique service identifier;
storing, by the processor, the enhanced request data object in a transaction tracking database including a plurality of enhanced request data objects categorized by application and indexed, for each categorized application, by respective timestamps, unique user identifiers, and unique service identifiers;
processing, by the processor, the request data object using the application, by executing a plurality of processing steps performed by one or more computing systems associated with the application, wherein responsive to each processing step, the enhanced request data object is updated with a status indicator of each processing step; and
outputting, by the processor, a control signal associated with one or more status indicators of the enhanced request data object.

2. The method of claim 1, further comprising:
determining, based on evaluation of the one or more status indicators of the enhanced request data object, a failure in a processing step; and
causing, responsive to determining the failure, an exception function.

3. The method of claim 2, wherein causing the exception function comprises:
executing the processing step a second time.

4. The method of claim 2, wherein causing the exception function comprises:
routing the request data object to a different computing system within a computing architecture associated with the application.

5. The method of claim 1, wherein the additional metadata further comprises timestamp data indicating a start time for processing the request data object, wherein each processing step comprises respective processing timestamps, wherein the method further comprises:
determining, based on evaluating the start time against a respective processing timestamp for a respective processing step, that a timing threshold is satisfied;
updating, responsive to determining that the timing threshold is satisfied, a status indicator of the enhanced request data object for the respective processing step to failed; and
modifying the control signal to include an indication specifying the respective processing step that failed.

6. The method of claim 1, further comprising:
monitoring, on a periodic basis, the transaction tracking database by parsing each enhanced request data object; and
generating and outputting a status report comprising a list of all enhanced request data objects having at least one failed status indicator for a time period.

7. The method of claim 1, further comprising:
determining, based on evaluation of the control signal, that processing of the request data object is complete; and
removing, responsive to completion of processing of the request data object, the enhanced request data object from the transaction tracking database thereby freeing up a memory space in the transaction tracking database.

8. The method of claim 1, wherein the one or more status indicators comprises one of success, fail, or null.

9. The method of claim 8, wherein the one or more status indicators are set to null for processing steps that have not been executed.

10. The method of claim 1, where the structured format comprises a JavaScript Object Notation (JSON) format, an Extensible Markup Language (XLM) format, or a Comma-Separated Values (CSV) format.

11. The method of claim 1, wherein the unique user identifier is associated with an account number of a user profile associated with the request.

12. The method of claim 1, wherein the unique service identifier is generated using a random alphanumeric generator.

13. A system comprising:
one or more processors; and
a memory coupled to the one or more processors, the memory including instructions that, when executed by the one or more processors, cause the one or more processors to:
receive, by a processor of a computing device, a communication from a third-party computing device, wherein the communication is associated with a request to interact with an application hosted by an enterprise associated with the computing device;
transform, by the processor and based on the request, the communication into a structured format using an application program interface (API) associated with the application specified in the request thereby generating a request data object, wherein the request data object comprises a unique user identifier and user metadata associated with the request;
generate an enhanced request data object by injecting the request data object with additional metadata, the additional metadata including a unique service identifier;
store the enhanced request data object in a transaction tracking database including a plurality of enhanced request data objects categorized by application and indexed, for each categorized application, by respective timestamps, unique user identifiers, and unique service identifiers;
process the request data object using the application, by executing a plurality of processing steps performed by one or more computing systems associated with the application, wherein responsive to each processing step, the enhanced request data object is updated with a status indicator of each processing step; and
output a control signal associated with one or more status indicators of the enhanced request data object.

14. The system of claim 13, wherein the one or more processors are further configured to:
determine, based on evaluation of the one or more status indicators of the enhanced request data object, a failure in a processing step; and
causing, responsive to determining the failure, an exception function, wherein causing the exception function comprises executing the processing step a second time or routing the request data object to a different computing system within a computing architecture associated with the application.

15. The system of claim 13, wherein the additional metadata further comprises timestamp data indicating a start time for processing the request data object, wherein each processing step comprises respective processing timestamps, wherein the one or more processors are further configured to:
determine, based on evaluating the start time against a respective processing timestamp for a respective processing step, that a timing threshold is satisfied;
update, responsive to determining that the timing threshold is satisfied, a status indicator of the enhanced request data object for the respective processing step to failed; and
modify the control signal to include an indication specifying the respective processing step that failed.

16. The system of claim 13, wherein the one or more processors are further configured to:
monitor, on a periodic basis, the transaction tracking database by parsing each enhanced request data object; and
generate and outputting a status report comprising a list of all enhanced request data objects having at least one failed status indicator for a time period.

17. The system of claim 13, wherein the one or more processors are further configured to:
determine, based on evaluation of the control signal, that processing of the request data object is complete; and
remove, responsive to completion of processing of the request data object, the enhanced request data object from the transaction tracking database thereby freeing up a memory space in the transaction tracking database.

18. A non-transitory computer-readable medium embodying program code that is executable by one or more processors to cause the one or more processors to:
receive, by a processor of a computing device, a communication from a third-party computing device, wherein the communication is associated with a request to interact with an application hosted by an enterprise associated with the computing device;
transform, by the processor and based on the request, the communication into a structured format using an application program interface (API) associated with the application specified in the request thereby generating a request data object, wherein the request data object comprises a unique user identifier and user metadata associated with the request;
generate an enhanced request data object by injecting the request data object with additional metadata, the additional metadata including a unique service identifier;
store the enhanced request data object in a transaction tracking database including a plurality of enhanced request data objects categorized by application and indexed, for each categorized application, by respective timestamps, unique user identifiers, and unique service identifiers;
process the request data object using the application, by executing a plurality of processing steps performed by one or more computing systems associated with the application, wherein responsive to each processing step, the enhanced request data object is updated with a status indicator of each processing step; and
output a control signal associated with one or more status indicators of the enhanced request data object.

19. The non-transitory computer-readable medium of claim 18, wherein the additional metadata further comprises timestamp data indicating a start time for processing the request data object, wherein each processing step comprises respective processing timestamps, wherein the one or more processors are further configured to:
determine, based on evaluating the start time against a respective processing timestamp for a respective processing step, that a timing threshold is satisfied;
update, responsive to determining that the timing threshold is satisfied, a status indicator of the enhanced request data object for the respective processing step to failed; and
modify the control signal to include an indication specifying the respective processing step that failed.

20. The non-transitory computer-readable medium of claim 18, wherein the one or more processors are further configured to:
determine, based on evaluation of the control signal, that processing of the request data object is complete; and
remove, responsive to completion of processing of the request data object, the enhanced request data object from the transaction tracking database thereby freeing up a memory space in the transaction tracking database.
